(19) United States
(12) Patent Application Publication
(10) Pub. No.: US 2009/0039793 A1
(43) Pub. Date: Feb. 12, 2009

(54) Compact fluorescent lamp

(76) Inventors: Charles Bolta, Boulder, CO (US); Dennis Clark, Boulder, CO (US)

Correspondence Address: EMERY L. TRACY, P.O. BOX 1518, BOULDER, CO, 80306, US

(21) Appl. No.: 12/220,892

(22) Filed: Jul. 29, 2008

Related U.S. Application Data
(60) Provisional application No. 60/962,857, filed on Aug. 1, 2007.

(51) Int. Cl. H05B 35/00; H01J 9/00

(52) U.S. Cl. 315/182; 445/26

(57) ABSTRACT

A switchable compact fluorescent lamp with an L.E.D. added to the center of the top of the compact fluorescent lamp plastic electronic encasement housing. The L.E.D. can be switched on with the fluorescent on or switched to be on by itself with the fluorescent off. The lamp can also be switched to a battery and or capacitor power backup for the L.E.D. when the power goes off.

The present application claims benefit of priority of pending provisional patent application Ser. No. 60/962,857, filed on Aug. 1, 2007, entitled “Afterglow Amplifier Emitter for Compact Fluorescent Lamps”.

### BACKGROUND OF THE INVENTION

1. Field of the Invention

The present invention relates generally to a compact fluorescent lamp and more particularly the invention relates to a switchable compact fluorescent lamp with a light emitting diode (L.E.D.) to maximize energy efficiency, an emergency backup L.E.D. light system, a fan to cool the compact fluorescent lamp electronics and move air through the TiO₂ coated fluorescent glass area, an afterglow pedestal L.E.D. mounting system and plug imports for external power.

2. Description of the Prior Art

Compact fluorescent lamps are commonly found in essentially most residential and commercial buildings. Furthermore during this age of energy conservation the use of compact fluorescent lamps will be the common lamp used in the future, replacing incandescent lamps, which the US government is outlawing beginning 2012. Typically a compact fluorescent lamp is used in place of a standard incandescent lamp to reduce energy usage and increase the time that the lamp needs to be replaced.

Incandescent lamps and compact fluorescent lamps are commonly used for general lighting such as overhead fixtures, table lamps and night lights. Today L.E.D.s are starting to be used in general lighting with limited success and usage. L.E.D. lighting by itself will not effectively luminate a room evenly and as fully as a compact fluorescent lamp, leaving dark areas 360 degrees away from the L.E.D. lighting. Furthermore, the cost of a L.E.D. lamp for an equivalent amount of lumens from a compact fluorescent lamp is far more expensive than a compact fluorescent lamp lamp.

Typically an emergency back up lighting system is a fixture with a battery pack placed on a wall. The emergency back up system generally has the lamps in the off position and when the power is cut the lamps would come on. Incandescent lamps have generally been used for emergency back up systems. Another back up emergency lighting system using fluorescent lamps would have the lamps lit as general lighting and when the power is cut, the same lamp would continue to light up under battery power. In the event of an emergency, such as a building fire, emergency back-up lighting plays a crucial role in enabling people to safely exit the building in a timely manor. The light output and time is regulated by Underwriters Laboratories (U.L.) to burn at least 90 minutes which make incandescent or fluorescents limited in their usage.

In a mine or military command center, an emergency black out event could last days and much longer than the 90 minutes required by U.L. specifications.

Photo-luminescent phosphors known commonly as afterglow have been used in materials or plastics which have been used for emergency exit signs more noticeably in the past few years after 9/11. Afterglow exit signs and stair strips help people evacuate a building or area more safely and quickly. The photo-luminescent material absorbs light from the lighting in the room and when the lights go out, the afterglow materials glow in the dark for a period of time, unfortunately the decay rate of the afterglow is quite fast and steep. An exit sign can even ruminate the immediate area so a person can see slightly and navigate, but for a short period of time because of the fast decay rate.

Titanium Dioxide (TiO₂) coating have shown to be an effective air purifying system to reduce airborne microorganisms. In the past, a fluorescent compact lamp has had the TiO₂ coating put on the glass of the lamp and through convection of heat results in air movement passes over the TiO₂ coating and the light from the compact fluorescent lamp results in a photo catalytic oxidation process.

The TiO₂ coating process in its usage with a compact fluorescent lamp has a noted limitation of low air passage over the TiO₂ coated glass. While heat convention can work in some environments, heat convection has a limitation of air volume coverage in a room.

During this age of energy efficiency and global warming, there is a need for an effective way to reduce energy. To achieve this goal, an attractive option is to use a L.E.D. and switchable compact fluorescent lamp. In the average home the expense and installation of a commercial emergency back up lighting system would be prohibitive. Accordingly there exists a need for an inexpensive energy saving compact fluorescent lamp with an emergency capacitor or battery back up L.E.D. lamp system.

Furthermore, the spreading of germs of a cold or flu in a house or office is a common event. Accordingly a compact fluorescent lamp with TiO₂ coating with a fan to spread the TiO₂ activated air around the room would increase the effectiveness of the TiO₂ system.

### SUMMARY

The present invention is a compact fluorescent lamp comprising a compact fluorescent lamp base. Fluorescent tubing extends from the lamp base. An L.E.D. is mounted to the lamp base. Switch means illuminates the fluorescent tubing and the L.E.D.

In an embodiment of the present invention, the switch means is a switch movable between illuminating the fluorescent tubing, illuminating the L.E.D., illuminating both the fluorescent tubing and the L.E.D., and turning off illumination of the fluorescent tubing and the L.E.D. The switch means can be mounted to the lamp base or be remote from the lamp base. Further, the remote could be a frequency activated switching system. Furthermore the remote frequency activated system can actuate dimming capabilities for both the compact fluorescent and L.E.D. to further reduce energy usage.

In another embodiment of the present invention, a battery is mounted to the lamp base, the battery powering the L.E.D.

In still another embodiment of the present invention, a pedestal is mounted to the base and extending through the fluorescent tubing wherein the L.E.D. is mounted on the pedestal beyond the extent of the fluorescent tubing.

In yet another embodiment of the present invention, the pedestal has a plurality of air holes, and a fan is mounted to the base with the fan directed through the pedestal toward the L.E.D.

In still yet another embodiment of the present invention, a fiber optic pedestal is mounted to the base and extending through the fluorescent tubing.

### BRIEF DESCRIPTION OF THE DRAWINGS

Before explaining the disclosed embodiment of the present invention in detail, it is to be understood that the invention is not limited to its application to the details of the particular arrangement as shown, since the invention is capable of different embodiments. Also, the terminology used herein is for the purpose of description and not of limitation.

FIG. 1 is an elevational side view illustrating a compact fluorescent lamp, constructed in accordance with the present invention, with an L.E.D. placed on top of a compact fluorescent lamp base electronic cap of the housing with a multiple engagement switch;

FIG. 2 is an elevational side view illustrating the compact fluorescent lamp, constructed in accordance with the present invention, with an L.E.D. on a pedestal mount through the center of the glass tubing and out the top of the glass portion of the fluorescent tubing with a multiple engagement switch;

FIG. 3 is an elevational side view illustrating the compact fluorescent lamp, constructed in accordance with the present invention, with an L.E.D. at the base of a fiber optic lens that runs through the center of the glass tubing and out the top of the tubing with a multiple engagement switch;

FIG. 4 is an elevational side view illustrating the compact fluorescent lamp, constructed in accordance with the present invention, with an added fan and an afterglow pedestal mount with air holes for air circulation; and

FIG. 5 is an elevational side view illustrating the compact fluorescent lamp, constructed in accordance with the present invention, with an added external battery pack with extra import receptacle.

### DETAILED DESCRIPTION OF THE PREFERRED EMBODIMENTS

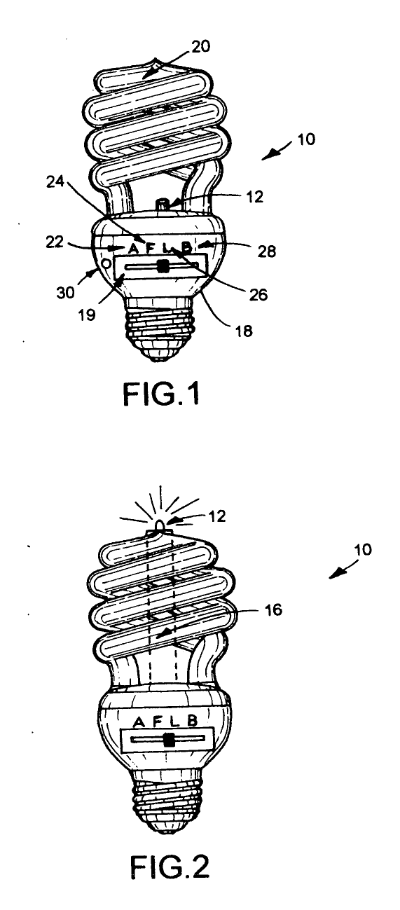

As illustrated in FIGS. 1-5, the present invention is a switchable compact fluorescent lamp, indicated generally at 10, with a light emitting diode (L.E.D.) 12 to maximize energy efficiency, an emergency backup L.E.D. light system, a fan 14 to cool the compact fluorescent lamp electronics and move air through the TiO₂ coated fluorescent glass area, an afterglow pedestal L.E.D. mounting system 16 and plug imports for external power.

As illustrated in FIG. 1, a compact fluorescent lamp already starts off with lower usage of electricity than an incandescent lamp and with a switchable compact fluorescent lamp 10, as set forth in the present invention, with an added L.E.D. 12 system an even further reduction of energy usage can be achieved. The switchable compact fluorescent lamp 10 with an L.E.D. 12 added to the center of the top of the compact fluorescent lamp plastic electronic encasement housing 18 to maximize energy efficiency. Two different types of lamps, a compact fluorescent lamp 10 and an L.E.D. 12, are used to further reduce energy consumption by manual or remote selection. With manual operation, a switch 19 is provided to illuminate the fluorescent tubing 20 and the L.E.D. 12 together (indicated by “A” 22), illuminate the fluorescent tubing 20 only (indicated by “F” 24), illuminate the L.E.D. 12 only (indicted by “L” 26), or illuminate only the L.E.D. 12 on battery back up (indicated by “B” 28). A remote switching system could be installed to switch the different setting of the compact fluorescent lamp in areas of difficult locations.

The addition of an L.E.D. to the compact fluorescent lamp 10 of the present invention serves multiple purposes. First, adding an L.E.D. 12 to the compact fluorescent lamp 10 increases the life of the compact fluorescent lamp 10 by using the L.E.D. 12 at night as a night light rather than the fluorescent tubing 20 of the compact fluorescent lamp for reduced energy usage. Second, the compact fluorescent lamp 10 with the L.E.D. 12 switched on to power back-up for emergencies still illuminates even in the event of an explosion or concussion or damage resulting in breakage of the glass encasement of the fluorescent tubing 20 of the compact fluorescent lamp 10.

In addition to the above, afterglow materials can be added to the air channel or pedestal tube system and could further be fitted with a timed L.E.D. system to come on at predetermined timed sequences to extend the length of emitable afterglow light by charging the afterglow material then shutting off to save battery or energy usage in long emergencies. The L.E.D. can be switched on with the fluorescent on or switched to be on by itself with the fluorescent off. The lamp can also be switched to a battery power back-up setting and or capacitor power backup for the L.E.D. when the power goes off or to run on battery only. The compact fluorescent lamp 10 can also be removed from the socket and switched to L.E.D. power back up and function as a flashlight.

Both the L.E.D. 12 and the switchable compact fluorescent lamp 10 can be run on 120 volt, 240 volt or 12 volt A.C. or D.C. The D.C. lamp works efficiently in solar powered homes, RV's, boats or trailers that produce and or run on D.C. power. If more light is needed, just flip the switch to all on and use both light sources or just the fluorescent tubing 20 of the compact fluorescent lamp 10 or just the L.E.D. 12 of the compact fluorescent lamp 10. Furthermore, the switchable compact fluorescent lamp 10 can also be run directly off a solar panel or larger D.C. external power pack with an added import plug-in receptacle 30 in the compact fluorescent lamp base housing. The import plug-in receptacle can be used for adding an external battery pack, an external solar panel, or any compatible power source to power the compact fluorescent lamp including the extra features.

The switchable compact fluorescent lamp 10 of the present invention can also be incorporated into a cold cathode type self ballasted or remote ballasted lamp. The switchable compact fluorescent lamp 10 and features can also be incorporated into a remote ballasted fluorescent lamp system and even standard linear fluorescent lamps and ballasts.

As illustrated in FIG. 2, in another embodiment of the compact fluorescent lamp 10 of the present invention, to adapt the L.E.D. 12 to the compact fluorescent lamp glass design, a pedestal mount 16 can also be put through the center of the compact fluorescent lamp 10 and out the top of the fluorescent glass tubing 20 to give a clear un-obstructive avenue for the L.E.D. light stream. The L.E.D. 12 can then to be placed on the top of the pedestal 16 and illuminate a larger area without being blocked by the glass of the fluorescent tubes 20. Furthermore, wiring for the L.E.D. 12 can be run through the pedestal tube 20.

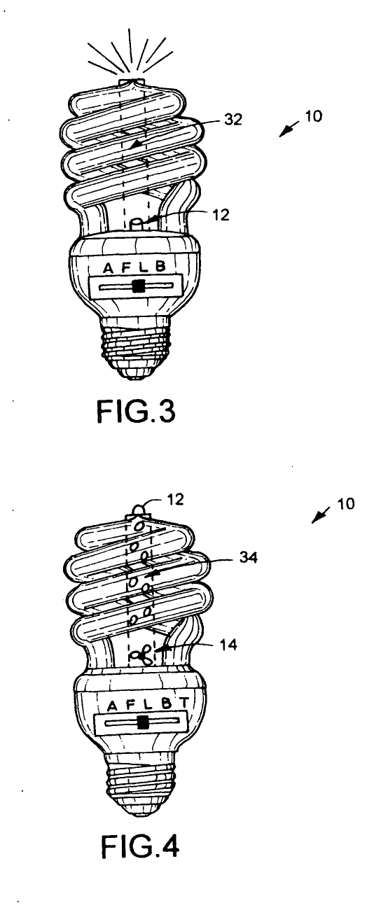

As illustrated in FIG. 3, in still another embodiment of the compact fluorescent lamp 10 of the present invention, a clear plastic fiber optic lens 32 can be put through the compact fluorescent lamp tubing 20 and out the top of the glass fluorescent tubing 20. Furthermore, a split fiber optic lens 32 can be added to adapt to the design of the compact fluorescent lamp 10 and bring the light up to the top of the fluorescent glass 20 of the compact fluorescent lamp 10, as needed. The L.E.D. 12 is placed at the base of the plastic fiber optic lens 32 and shines through the lens. Further, multiple L.E.D.s 12 can be added to the compact fluorescent lamp 10 in multiple areas to increase lumen output.

As illustrated in FIG. 4, in still yet another embodiment of the compact fluorescent lamp 10 of the present invention, the TiO₂ coating process in its usage with a compact fluorescent lamp has a noted limitation of low air passage over the TiO₂ coated glass. While heat convention can work in some environments, heat convection has a limited area of room coverage and volume.

With the compact fluorescent lamp 10 of the present invention, a fan 14 and air channel 34 are provided to maximize the amount of air passing over the TiO₂ covered fluorescent glass. Furthermore, the photo-catalytic reactive air is moved further away from the compact fluorescent lamp 10 and covers more area in a room. A switchable or non-switchable compact fluorescent lamp with a fan 14, and with or without an air channel, can effectively move larger amounts air through the compact fluorescent lamp 10 maximizing its effectiveness. The air channel with its multi ported air holes can direct air flow three hundred and sixty (360°) degrees through the center of the TiO2 coated compact fluorescent lamp 10 covering more surface area of the TiO2 coated glass of the lamp. The added fan 14 can also be used to cool the electronics of the compact fluorescent lamp and glass of the lamp extending life expectancy of the lamp and even the L.E.D. if placed on top of the air channel. The switch 19 can have an additional setting, “T”, for the TiO₂ fan setting.

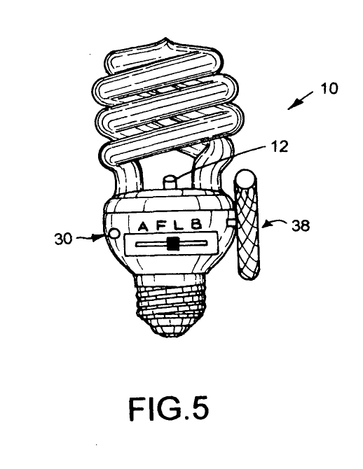

As illustrated in FIG. 5, the compact fluorescent lamp 10 of the present invention has multiple external energy packs 38 which can also have different types of energy releases such as regular batteries or capacitors or even a direct solar or large battery packs such as a car battery. An external plug 30 and play battery pack 38 with or without an internal battery charger can further be added to the outside of the compact fluorescent lamp 10 to increase time of emergency light output. An internal charger inside the compact fluorescent lamp 10 can also charge the internal and or external batteries for the emergency backup system.

With the switchable compact fluorescent lamp 10 with a L.E.D. light 12 setting to further reduce energy usage in the same compact fluorescent lamp and extend the life of the compact fluorescent lamp and reduce power consumption.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

1. A compact fluorescent lamp comprising:
a compact fluorescent lamp base;
fluorescent tubing extending from the lamp base;
an L.E.D. mounted to the lamp base; and
switch means for illuminating the fluorescent tubing and the L.E.D.

2. The compact fluorescent lamp of claim 1 wherein the switch means is a switch movable between illuminating the fluorescent tubing, illuminating the L.E.D., illuminating both the fluorescent tubing and the L.E.D., and turning off illumination of the fluorescent tubing and the L.E.D.

3. The compact fluorescent lamp of claim 1 wherein the switch means is mounted to the lamp base.

4. The compact fluorescent lamp of claim 1 wherein the switch means is remote from the lamp base.

5. The compact fluorescent lamp of claim 1 and further comprising:
an external battery mounted to the lamp base, the battery powering the L.E.D.

6. The compact fluorescent lamp of claim 1 and further comprising:
an internal battery mounted inside the lamp base, the battery powering the L.E.D.

7. The compact fluorescent lamp of claim 1 and further comprising:
an internal charging system mounted inside the lamp base, charging the internal battery, the battery powering the L.E.D.

8. The compact fluorescent lamp of claim 1 and further comprising:
a pedestal mounted to the base and extending through the fluorescent tubing;
wherein the L.E.D. is mounted on the pedestal beyond the extent of the fluorescent tubing.

9. The compact fluorescent lamp of claim 8 wherein the pedestal is hollow and has a plurality of air holes, and further comprising:
a fan mounted to the base, the fan directed through the pedestal toward the L.E.D.

10. The compact fluorescent lamp of claim 8 wherein the pedestal is hollow and has the plurality of air holes, and further comprising:
a fan mounted inside the pedestal, the fan directing air through the pedestal.

11. The compact fluorescent lamp of claim 8 wherein the pedestal is hollow has the plurality of air holes, and further comprising:
afterglow photoluminescent phosphor material added to the pedestal.

12. The compact fluorescent lamp of claim 8 wherein the pedestal is hollow and has the plurality of air holes, and further comprising:
a timed and sequenced L.E.D. system to charge afterglow materials.

13. The compact fluorescent lamp of claim 1 and further comprising:
a fiber optic pedestal mounted to the base and extending through the fluorescent tubing.

14. A method for constructing a compact fluorescent lamp, the method comprising:
providing a compact fluorescent lamp base;
extending fluorescent tubing from the lamp base;
mounting an L.E.D. mounted to the lamp base; and
illuminating the fluorescent tubing and/or the L.E.D.

13. (canceled)

14. (canceled)

15. The method of claim 14 and further comprising:
mounting an external battery to the lamp base; and
powering the L.E.D.

16. The method of claim 14 and further comprising:
mounting an internal battery inside the lamp base; and
powering the L.E.D.

17. The method of claim 14 and further comprising:
mounting an internal charging system inside the lamp base;
charging the internal battery; and
powering the L.E.D.

18. The method of claim 14 and further comprising:
mounting a pedestal to the base;
extending the pedestal through the fluorescent tubing; and
mounting the L.E.D. to the pedestal beyond the extent of the fluorescent tubing.

19. The method of claim 18 wherein the pedestal is hollow, and further comprising:
forming a plurality of air holes in the pedestal;
mounting a fan within the pedestal; and
directing the fan through the pedestal toward the L.E.D.

20. The method of claim 18 and further comprising:
adding an afterglow photoluminescent phosphor material to the pedestal.
